(19) United States
(12) Patent Application Publication
(10) Pub. No.: US 2026/0196757 A1
(43) Pub. Date: Jul. 9, 2026

(54) CONNECTOR HOUSING AND CONNECTOR

(71) Applicants: Tyco Electronics (Suzhou) Ltd., Suzhou City (CN); Tyco Electronics (Shanghai) Co., Ltd., Shanghai (CN)

(72) Inventors: Kang Zhou, Suzhou (CN); Jun Zong, Shanghai (CN); Tao (Thomson) Dong, Suzhou (CN); Tommy Qian, Shanghai (CN)

(73) Assignees: Tyco Electronics (Suzhou) Ltd., Suzhou City (CN); Tyco Electronics (Shanghai) Co., Ltd., Shanghai (CN)

(21) Appl. No.: 19/441,196

(22) Filed: Jan. 6, 2026

(30) Foreign Application Priority Data
Jan. 6, 2025 (CN) 202510025099.9

(51) Int. Cl. H01R 12/77; H01R 13/422; H01R 13/50; H01R 13/627; H01R 43/18; H01R 43/20

(52) U.S. Cl. CPC H01R 12/774; H01R 12/777; H01R 13/422; H01R 13/501; H01R 13/6273; H01R 43/18; H01R 43/20

(57) ABSTRACT

A connector housing includes a housing body and a first snap lock. The housing body has a row of first insertion holes, and a first snap slot. The first snap slot is in communication with the row of first insertion holes. Each first insertion hole receives one first terminal of a row of first terminals. The first snap lock has a first cantilever connected to the housing body, and a first hook at a tail end of the first cantilever. The first snap lock moves between a locked position and an unlocked position. A row of first ribs respectively corresponding to the row of first insertion holes are formed on the first hook. The row of first ribs respectively abut against the row of first terminals when the first hook is engaged with the first snap slot.

### CROSS-REFERENCE TO RELATED APPLICATION

This application claims the benefit of the filing date under 35 U.S.C. § 119(a)-(d) of Chinese Patent Application No. CN202510025099.9 filed on Jan. 6, 2025, the whole disclosure of which is incorporated herein by reference.

### FIELD OF THE INVENTION

The present invention relates to a connector housing and, more particularly, to a connector housing, and a connector including the connector housing.

### BACKGROUND OF THE INVENTION

A connector for electrical connection with a flexible flat cable or a flexible circuit board includes a housing and a row of terminals. A row of terminal insertion holes are formed in the housing and extend in a longitudinal direction of the housing. The row of terminals are inserted into the row of terminal insertion holes. In order to reliably lock the row of terminals in the row of terminal insertion holes, a snap lock (commonly referred to as a secondary lock) and a snap slot are usually formed on the housing. The snap slot extends in a transverse direction of the housing and is in communication with the row of terminal insertion holes. The snap lock is capable of moving between a locked position in which it is engaged with the snap slot and an unlocked position in which it is disengaged from the snap slot. The snap slot shortens the creepage distance between two adjacent terminals, and there is a risk of a short circuit when the connector is used for high voltage, which reduces safety in use of the connector.

### SUMMARY OF THE INVENTION

A connector housing includes a housing body and a first snap lock. The housing body has a row of first insertion holes, and a first snap slot. The first snap slot is in communication with the row of first insertion holes. Each first insertion hole receives one first terminal of a row of first terminals. The first snap lock has a first cantilever connected to the housing body, and a first hook at a tail end of the first cantilever. The first snap lock moves between a locked position and an unlocked position. A row of first ribs respectively corresponding to the row of first insertion holes are formed on the first hook. The row of first ribs respectively abut against the row of first terminals when the first hook is engaged with the first snap slot.

### BRIEF DESCRIPTION OF DRAWINGS

The invention will now be described by way of example with reference to the accompanying figures, of which:

FIG. 1 is a perspective view of a connector according to an exemplary embodiment, with a snap lock in a locked position;

FIG. 2 is an exploded sectional view of the connector of FIG. 1;

FIG. 3 is a partially enlarged sectional view of a connector housing shown in FIG. 2;

FIG. 4 is a top perspective view of the connector housing of FIG. 3;

FIG. 5 is a bottom perspective view of the connector housing of FIG. 3;

FIG. 6 is a longitudinal sectional view of the connector of FIG. 1;

FIG. 7 is a partially enlarged sectional view of the connector of FIG. 1 as shown in FIG. 6;

FIG. 8 is a transverse sectional view of the connector of FIG. 1;

FIG. 9 is a partially enlarged sectional view of the connector of FIG. 1 as shown in FIG. 8;

FIG. 10 is a horizontal sectional view of the connector of FIG. 1;

FIG. 11 is a horizontal sectional view of the connector housing of FIG. 3; and

FIG. 12 is a partially enlarged sectional view of the connector housing of FIG. 3 as shown in FIG. 11.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

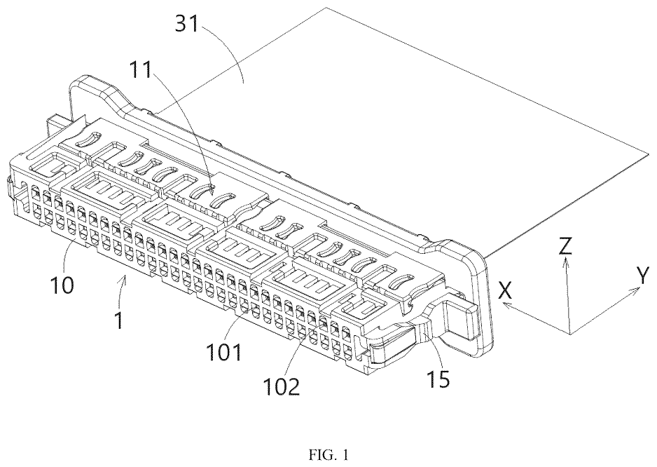

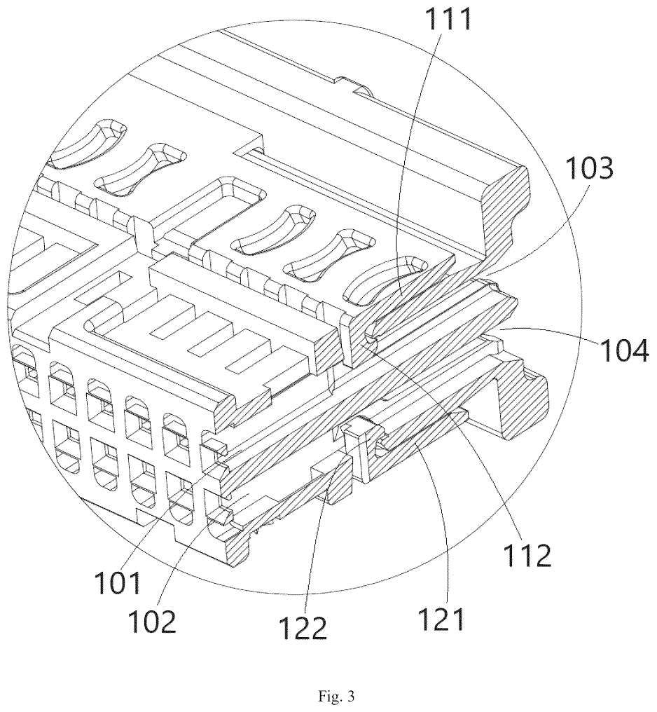

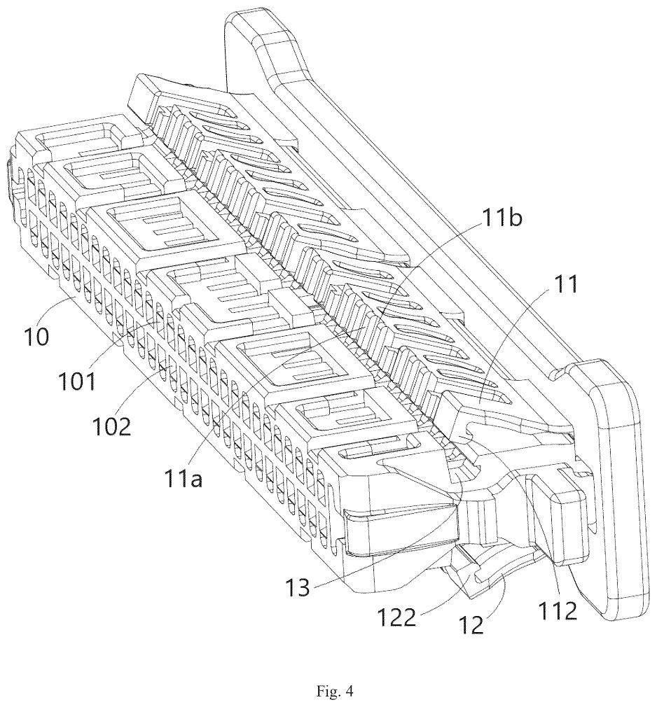

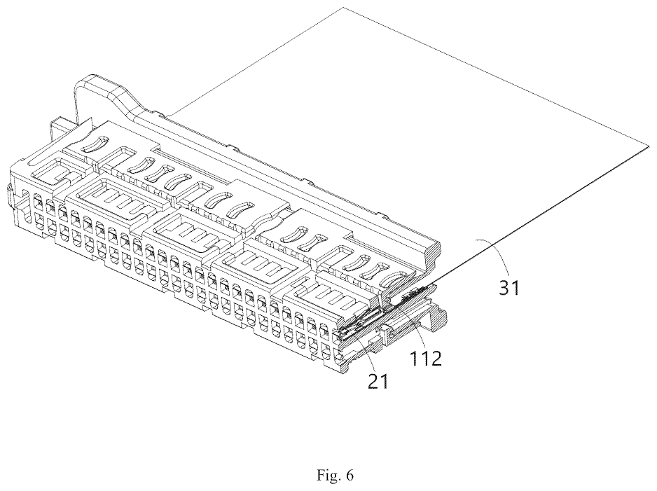

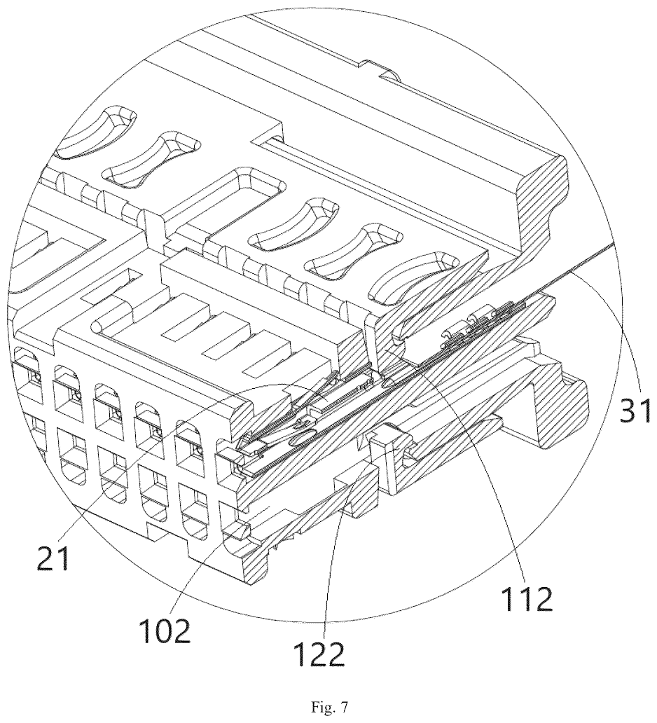

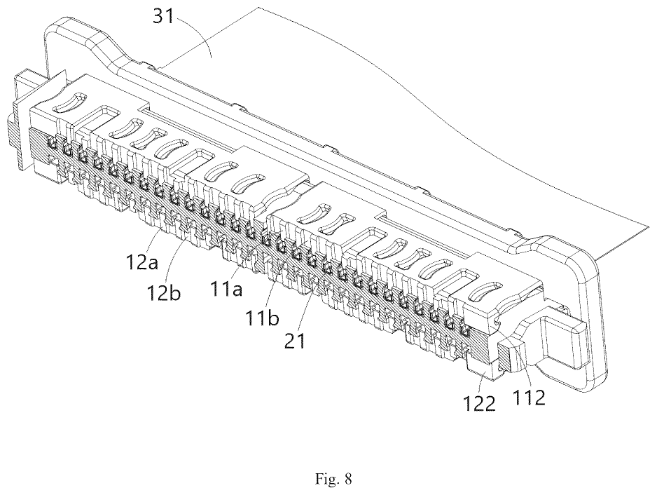

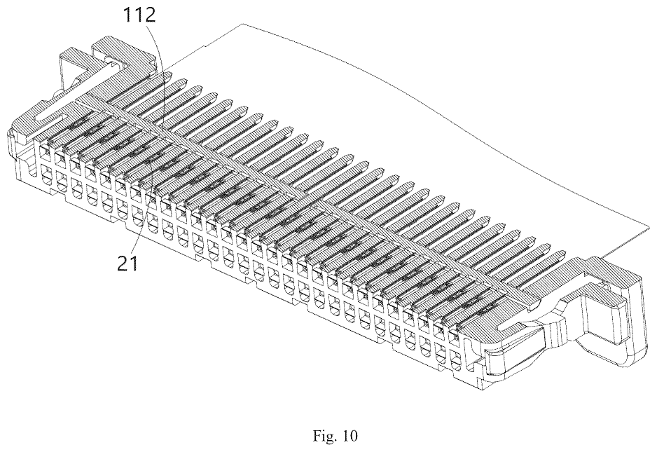

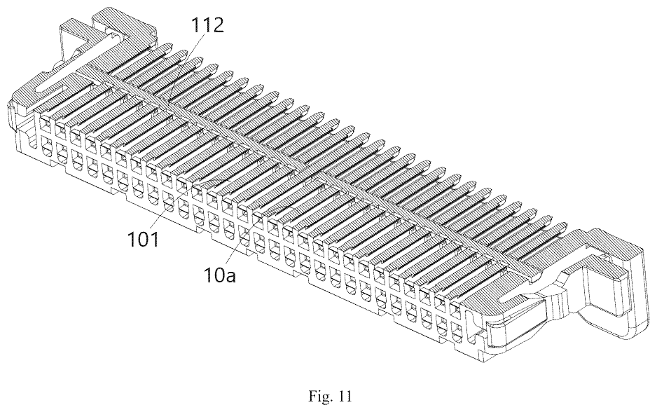

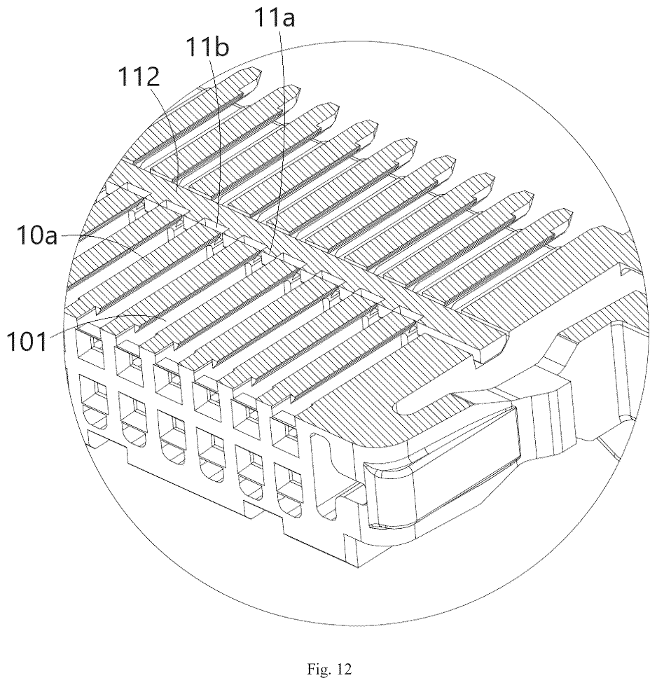

An exemplary embodiment of a connector housing 1 will now be described with reference to FIGS. 1-12. As shown in FIGS. 1-2 and 4-5, the connector housing 1 includes a housing body 10 and a first snap lock 11. As shown in FIG. 4, the housing body 10 has a row of first insertion holes 101 that extend in a longitudinal direction Y of the housing body 10 and are configured to receive a row of first terminals 21 and a first snap slot 13 that extends in a transverse direction X of the housing body 10 and is in communication with the row of first insertion holes 101. As shown in FIG. 3, the first snap lock 11 includes a first cantilever 111 and a first hook 112. The first cantilever 111 is connected to the housing body 10. The first hook 112 is located at a tail end of the first cantilever 111. The first snap lock 11 is adapted to move between a locked position in which the first hook 112 is engaged with the first snap slot 13 and an unlocked position in which the first hook 112 is disengaged from the first snap slot 13. A row of first ribs 11a, as shown in FIGS. 8-9 and 12, corresponding to the row of first insertion holes 101 respectively are formed on the first hook 112 for increasing a creepage distance between two adjacent first terminals 21. When the first hook 112 is engaged with the first snap slot 13, the row of first ribs 11a on the first hook 112 are adapted to abut against the row of first terminals 21 respectively to lock the row of first terminal 21 in the row of first insertion holes 101 to prevent the row of first terminal 21 from being pulled out of the connector housing 1.

As shown in FIGS. 4, 8-9, and 12, a row of first grooves 11b are further formed on the first hook 112. The row of first ribs 11a and the row of first grooves 11b are arranged alternately in the transverse direction X of the housing body 10. The first ribs 11a and the first grooves 11b are used to increase a creepage distance between two adjacent first terminals 21.

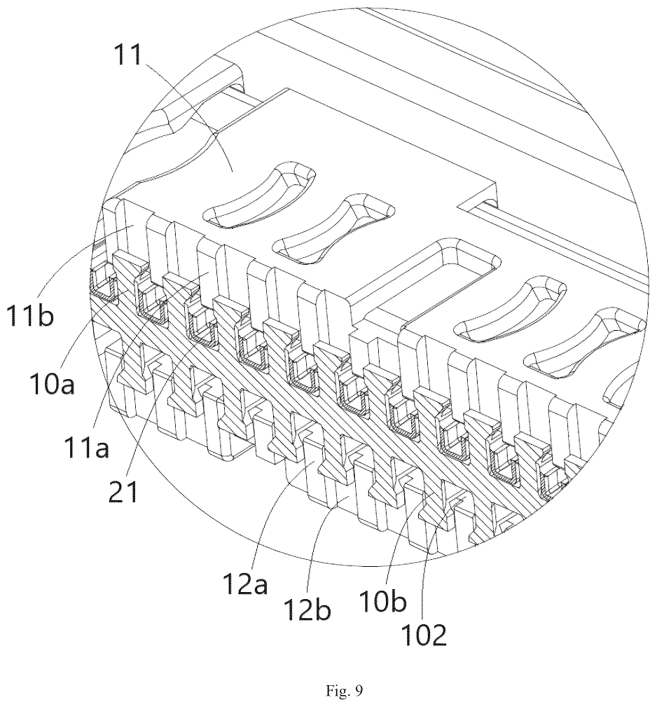

As shown in FIGS. 9 and 11-12, the housing body 10 has a row of first partition ribs 10a. Each of the first partition ribs 10a is configured to separate two adjacent first insertion holes 101. The row of first grooves 11b correspond to the row of first partition ribs 10a of the housing body 10, respectively.

When the first hook 112 is engaged with the first snap slot 13, the first ribs 11a and the first grooves 11b extend in a height direction Z of the housing body 10. Additionally, when the first hook 112 is engaged with the first snap slot 13, the row of first ribs 11a are aligned with the row of first insertion holes 101 respectively in the longitudinal direction Y of the housing body 10, and the row of first grooves 11b are aligned with the row of first partition ribs 10a respectively in the longitudinal direction Y of the housing body 10.

As shown in FIG. 4, the housing body 10 has a top wall and a bottom wall opposite each other in the height direction Z thereof. The first snap lock 11 is located on the top wall of the housing body 10. The first snap slot 13 is formed on the top wall of the housing body 10. The row of first insertion holes 101 are close to the top wall of the housing body 10.

As shown in FIGS. 1-5, 7, and 9, the housing body 10 further has a row of second insertion holes 102 that extend in the longitudinal direction Y of the housing body 10 and are configured to receive a row of second terminals 22 and a second snap slot 14 that extends in the transverse direction X of the housing body 10 and is in communication with the row of second insertion holes 102. The second snap slot 14 is formed on the bottom wall of the housing body 10. The row of second insertion holes 102 are close to the bottom wall of the housing body 10.

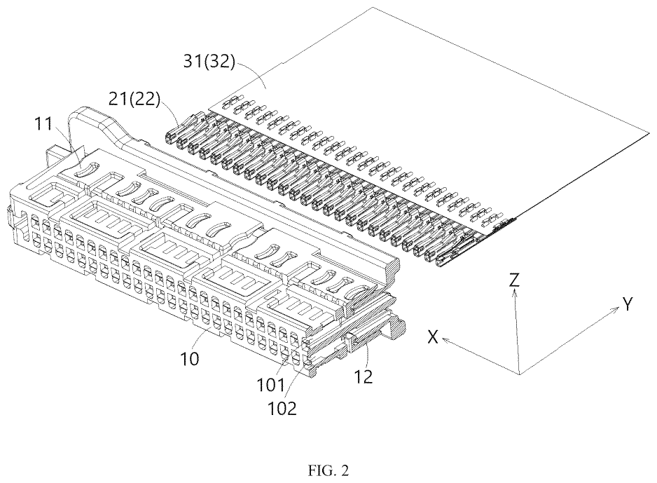

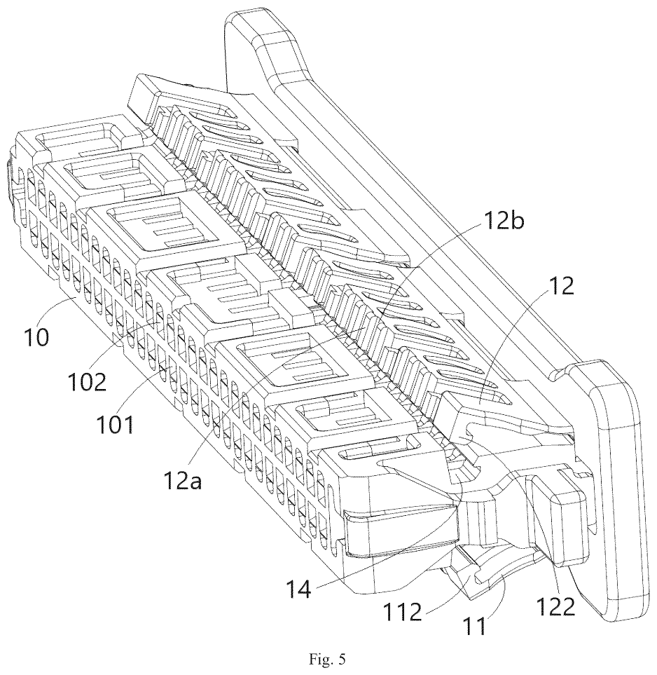

As shown in FIGS. 2 and 4-5, the connector housing 1 further includes a second snap lock 12 on the bottom wall of the housing body 10. As shown in FIG. 3, the second snap lock 12 includes a second cantilever 121 and a second hook 122. The second cantilever 121 is connected to the bottom wall of the housing body 10. The second hook 122 is located at a tail end of the second cantilever 121. The second snap lock 12 is adapted to move between a locked position in which the second hook 122 is engaged with the second snap slot 14 and an unlocked position in which the second hook 122 is disengaged from the second snap slot 14. A row of second ribs 12a, as shown in FIGS. 5 and 8-9, corresponding to the row of second insertion holes 102 respectively are formed on the second hook 122 for increasing a creepage distance between two adjacent second terminals 22. When the second hook 122 is engaged with the second snap slot 14, the row of second ribs 12a on the second hook 122 are adapted to abut against the row of second terminals 22 respectively to lock the row of second terminals 22 in the row of second insertion holes 102 to prevent the row of second terminal 22 from being pulled out of the connector housing 1.

As shown in FIGS. 5 and 8-9, a row of second grooves 12b are further formed on the second hook 122. The row of second ribs 12a and the row of second grooves 12b are arranged alternately in the transverse direction X of the housing body 10. The second ribs 12a and the second grooves 12b are used to increase a creepage distance between two adjacent second terminals 22.

As shown in FIG. 9, the housing body 10 has a row of second partition ribs 10b. Each of the second partition ribs 10b is configured to separate two adjacent second insertion holes 102. The row of second grooves 12b correspond to the row of second partition ribs 10b of the housing body 10, respectively.

When the second hook 122 is engaged with the second snap slot 14, the second ribs 12a and the second grooves 12b extend in the height direction Z of the housing body 10. Additionally, when the second hook 122 is engaged with the second snap slot 14, the row of second ribs 12a are aligned with the row of second insertion holes 102 respectively in the longitudinal direction Y of the housing body 10, and the row of second grooves 12b are aligned with the row of second partition ribs 10b respectively in the longitudinal direction Y of the housing body 10.

As shown in FIG. 1, the connector housing 1 further includes a pair of elastic latches 15. The pair of elastic latches 15 are respectively located on two opposite sides of the housing body 10 in the transverse direction X respectively and configured to be engaged with a mating housing of a mating connector to lock the connector housing 1 and the mating housing together. The connector housing 1 is a one-piece injection-molded part.

An exemplary embodiment of a connector will now be described with reference to FIGS. 1-12. The connector includes the connector housing 1 and the row of first terminals 21. The row of first terminals 21 are inserted into the row of first insertion holes 101 of the connector housing 1.

As shown in FIGS. 1-2 and 6-8, the connector further includes a first flexible flat member 31 for transmitting an electric current. The rear ends of the row of first terminals 21 are crimped to a front end of the first flexible flat member 31 for electrical connection with the first flexible flat member 31. The first flexible flat member 31 can be a flexible flat cable, and the row of first terminals 21 are electrically connected to a row of conductive core wires of the flexible flat cable, respectively. In another exemplary embodiment, the first flexible flat member 31 can be a flexible circuit board, and the row of first terminals 21 are electrically connected to a row of conductive traces of the flexible circuit board, respectively.

As shown in FIG. 3, a first slot 103 allowing the insertion of the front end of the first flexible flat member 31 is formed at a rear end of the housing body 10. The first slot 103 extends in a transverse direction X and a longitudinal direction Y of the housing body 10 and is in communication with the row of first insertion holes 101.

As shown in FIG. 2, the connector further includes a row of second terminals 22. The row of second terminals 22 are inserted into a row of second insertion holes 102 of the connector housing 1.

As shown in FIG. 2, the connector further includes a second flexible flat member 32 for transmitting an electric current. The rear ends of the row of second terminals 22 are crimped to a front end of the second flexible flat member 32 for electrical connection with the second flexible flat member 32. The second flexible flat member 32 can be a flexible flat cable, and the row of second terminals 22 are electrically connected to a row of conductive core wires of the flexible flat cable, respectively. In another exemplary embodiment, the second flexible flat member 32 can be a flexible circuit board, and the row of second terminals 22 are electrically connected to a row of conductive traces of the flexible circuit board, respectively.

As shown in FIG. 3, a second slot 104 allowing the insertion of the front end of the second flexible flat member 32 is formed at the rear end of the housing body 10. The second slot 104 extends in the transverse direction X and the longitudinal direction Y of the housing body 10 and is in communication with the row of second insertion holes 102.

In the aforementioned exemplary embodiments according to the present invention, the ribs and the grooves on the hook of the snap lock can increase the creepage distance between every two adjacent terminals, thus improving the safety in use of the connector.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector housing, comprising:
a housing body having a row of first insertion holes that extend in a longitudinal direction of the housing body, and a first snap slot, the first snap slot extends in a transverse direction of the housing body and is in communication with the row of first insertion holes, each first insertion hole receives one first terminal of a row of first terminals; and
a first snap lock having a first cantilever connected to the housing body, and a first hook at a tail end of the first cantilever, the first snap lock moves between a locked position in which the first hook is engaged with the first snap slot and an unlocked position in which the first hook is disengaged from the first snap slot, a row of first ribs respectively corresponding to the row of first insertion holes are formed on the first hook, the row of first ribs respectively abut against the row of first terminals when the first hook is engaged with the first snap slot.

2. The connector housing of claim 1, wherein a row of first grooves are formed on the first hook, the row of first ribs and the row of first grooves are arranged alternately in the transverse direction.

3. The connector housing of claim 2, wherein the housing body has a row of first partition ribs, each first partition rib separates two adjacent first insertion holes, the row of first grooves respectively correspond to the row of first partition ribs.

4. The connector housing of claim 3, wherein, when the first hook is engaged with the first snap slot, the row of first ribs and the row of first grooves extend in a height direction of the housing body.

5. The connector housing of claim 3, wherein, when the first hook is engaged with the first snap slot, the row of first ribs are respectively aligned with the row of first insertion holes in the longitudinal direction, and the row of first grooves are respectively aligned with the row of first partition ribs in the longitudinal direction.

6. The connector housing of claim 1, wherein the housing body has a top wall and a bottom wall opposite each other in a height direction of the housing body, the first snap lock is located on the top wall of the housing body, the first snap slot is formed on the top wall of the housing body, and the row of first insertion holes are adjacent to the top wall of the housing body.

7. The connector housing of claim 6, wherein the housing body has a row of second insertion holes that extend in the longitudinal direction, the row of second insertion holes receive a row of second terminals and a second snap slot that extends in the transverse direction and is in communication with the row of second insertion holes, the second snap slot is formed on the bottom wall of the housing body, the row of second insertion holes are adjacent to the bottom wall of the housing body, and the connector housing further comprises a second snap lock on the bottom wall of the housing body, the second snap lock includes a second cantilever and a second hook, the second cantilever is connected to the bottom wall of the housing body, the second hook is at a tail end of the second cantilever, and the second snap lock moves between a locked position in which the second hook is engaged with the second snap slot and an unlocked position in which the second hook is disengaged from the second snap slot, a row of second ribs respectively corresponding to the row of second insertion holes are formed on the second hook for increasing a creepage distance between two adjacent second terminals, when the second hook is engaged with the second snap slot, the row of second ribs on the second hook respectively abut against the row of second terminals to lock the row of second terminals.

8. The connector housing of claim 7, wherein a row of second grooves are formed on the second hook, the row of second ribs and the row of second grooves are arranged alternately in the transverse direction.

9. The connector housing of claim 8, wherein the housing body has a row of second partition ribs, each second partition rib separates two adjacent second insertion holes, and the row of second grooves respectively correspond to the row of second partition ribs.

10. The connector housing of claim 9, wherein, when the second hook is engaged with the second snap slot, the row of second ribs and the row of second grooves extend in the height direction.

11. The connector housing of claim 9, wherein, when the second hook is engaged with the second snap slot, the row of second ribs are respectively aligned with the row of second insertion holes in the longitudinal direction, and the row of second grooves are respectively aligned with the row of second partition ribs in the longitudinal direction.

12. The connector housing of claim 1, further comprising a pair of elastic latches each on one of two opposite sides of the housing body in the transverse direction, the pair of elastic latches are engaged with a mating housing of a mating connector to lock the connector housing and the mating housing together.

13. The connector housing of claim 12, wherein the connector housing is a one-piece injection-molded part.

14. A connector, comprising:
a connector housing includes a housing body and a first snap lock, the housing body has a row of first insertion holes that extend in a longitudinal direction of the housing body, and a first snap slot, the first snap slot extends in a transverse direction of the housing body and is in communication with the row of first insertion holes, the first snap lock has a first cantilever connected to the housing body, and a first hook at a tail end of the first cantilever, the first snap lock moves between a locked position in which the first hook is engaged with the first snap slot and an unlocked position in which the first hook is disengaged from the first snap slot, a row of first ribs respectively corresponding to the row of first insertion holes are formed on the first hook; and
a row of first terminals, each first terminal is inserted into one first insertion hole, the row of first ribs respectively abut against the row of first terminals when the first hook is engaged with the first snap slot.

15. The connector of claim 14, further comprising a first flexible flat member transmitting an electric current, rear ends of the row of first terminals are crimped to a front end of the first flexible flat member for electrical connection with the first flexible flat member.

16. The connector according to claim 15, wherein the first flexible flat member is a flexible flat cable, and the row of first terminals are respectively electrically connected to a row of conductive core wires of the flexible flat cable, or the first flexible flat member is a flexible circuit board, and the row of first terminals are respectively electrically connected to a row of conductive traces of the flexible circuit board.

17. The connector of claim 15, wherein a first slot allowing an insertion of the front end of the first flexible flat member is formed at a rear end of the housing body, the first slot extends in the transverse direction and the longitudinal direction and is in communication with the row of first insertion holes.

18. The connector of claim 14, further comprising a row of second terminals inserted into a row of second insertion holes of the connector housing.

19. The connector of claim 18, further comprising a second flexible flat member transmitting an electric current, rear ends of the row of second terminals are crimped to a front end of the second flexible flat member for electrical connection with the second flexible flat member.

20. The connector of claim 19, wherein the second flexible flat member is a flexible flat cable, and the row of second terminals are respectively electrically connected to a row of conductive core wires of the flexible flat cable, or the second flexible flat member is a flexible circuit board, and the row of second terminals are respectively electrically connected to a row of conductive traces of the flexible circuit board.

21. The connector of claim 19, wherein a second slot allowing an insertion of a front end of the second flexible flat member is formed at a rear end of the housing body, the second slot extends in the transverse direction and the longitudinal direction and is in communication with the row of second insertion holes.
